(19) United States
(12) Patent Application Publication
(10) Pub. No.: US 2026/0238558 A1
(43) Pub. Date: Aug. 13, 2026

(54) METHOD AND APPARATUS FOR GENERALIZING ARTIFICIAL INTELLIGENCE (AI)/ MACHINE LEARNING (ML) MODELS

(71) Applicant: MEDIATEK INC., Hsinchu City (TW)

(72) Inventors: Pedram KHEIRKHAH SANGDEH, San Jose, CA (US); Gyu Bum KYUNG, San Jose, CA (US)

(21) Appl. No.: 19/469,624

(22) PCT Filed: Apr. 3, 2024
(86) PCT No.: PCT/CN2024/085866

§ 371 Date: Sep. 26, 2025

Related U.S. Application Data
(60) Provisional application No. 63/494,490, filed on Apr. 6, 2023.

(51) Int. Cl. H04L 41/16; H04B 7/06

(52) U.S. Cl. CPC H04L 41/16; H04B 7/0626

(57) ABSTRACT

Apparatus and methods are provided for multi-rate encoding and decoding with generalizing AI/ML models. In one embodiment, the multi-rate encoder generates an intermediate output vector, performs generalization, wherein the generalization is one procedure selecting from a splitting-based generalization, a downsampling-based generalization, and a quantization-based generalization. In another embodiment, the decoder receives one or more latent vectors with different sizes from one or more encoders, performs generalization for each latent vector with an AI model, wherein the generalization is one procedure selecting from a zero-padding-based generalization, an upsampling-based generalization, and a dequantization-based generalization. In another embodiment, multi-rate AI/ML autoencoder including a multi-encoder and multi-rate decoder is provided. In one embodiment, the decoding AI model used by the decoder to perform generalization is of different nature from an encoding AI model used to generate the encoded data.

### CROSS REFERENCE TO RELATED APPLICATIONS

This application claims priority under 35 U.S.C. § 119 from U.S. Provisional Application No. 63/494,490 entitled “Method and Apparatus for Generalizing Artificial Intelligence (AI)/Machine Learning (ML) Models,” filed on Apr. 6, 2023. The disclosure of each of the foregoing documents is incorporated herein by reference.

### TECHNICAL FIELD

The disclosed embodiments relate generally to encoder and decoder, and, more particularly, generalizing artificial intelligence (AI) machine learning (ML) models for encoder/decoder.

### BACKGROUND

With the rapid development in the wireless communication, the utilization of multi-rate encoder/decoder architectures has emerged as a pivotal strategy, prominently addressing the escalating demands for enhanced efficiency and resilience within wireless networks. With the rapid expansion and intensifying requisites of modern wireless infrastructures, there arises a pressing need for adaptive solutions capable of accommodating diverse accuracies and overheads associated with Channel State Information (CSI) feedback. In this context, the adoption of multi-rate encoder/decoder configurations presents an advantageous approach, offering the versatility required to tailor CSI feedback mechanisms to varying network conditions and application requirements. The question remains how to achieve variable feedback rate/payload size. In a traditional way, a dedicated encoder/decoder for each applicable rate payload size is needed for generation and reconstruction. Such an approach, however, requires large configuration and resources.

Improvements and enhancements are required for the multi-rate encoder and decoder.

### SUMMARY

Apparatus and methods are provided for multi-rate encoding and decoding with generalizing AI/ML models. In one novel aspect, multi-rate AI-enabled encoder and decoder are provided. In one embodiment, the multi-rate encoder generates an intermediate output vector for an input data, wherein the intermediate output vector has a pre-defined length, performs generalization using the intermediate output vector with an AI model to generate multiple latent vectors, wherein a length of each latent vector is different, and wherein the generalization is one procedure selecting from a splitting-based generalization, a downsampling-based generalization, and a quantization-based generalization, and sends an encoded output to one or more decoders. In one embodiment, the input data is channel state information (CSI) obtained by an apparatus in a wireless network. In one embodiment, the splitting-based generalization involves: for each latent vector, selecting a portion of the intermediate output vector with a selection length equals to the length of corresponding latent vector. The downsampling-based generalization involves for each latent vector, passing the intermediate output vector to a corresponding downsampler with a predefined length equals to the length of corresponding latent vector. The quantization-based generalization involves for each latent vector, passing the intermediate output vector to a corresponding quantization codebook with predefined length equals to the length of corresponding latent vector. In one embodiment, each quantization codebook is a scalar quantization or a vector quantization. In one embodiment, the one or more decoders are single-rate decoders, multi-rate decoders, or a combination of single-rate and multi-rate decoders.

In another embodiment, the decoder receives one or more latent vectors with different sizes from one or more encoders, performs generalization for each latent vector with an AI model to generate corresponding intermediate input with a predefined fix decoder length, wherein the generalization is one procedure selecting from a zero-padding-based generalization, an upsampling-based generalization, and a dequantization-based generalization, and sends the intermediate input to a multi-rate decoder body to obtain an recovered vector. In one embodiment, the one or more latent vectors are encoded channel state information (CSI) obtained by an apparatus in a wireless network. In one embodiment, the zero-padding-based generalization involves: for each latent vector, performing zero-padding to get the immediate vector with the predefined fix decoder length. The upsampling-based generalization involves for each latent vector, passing the latent vector to a corresponding upsampler to get the immediate vector with the predefined fix decoder length. The dequantization-based generalization involves for each latent vector, passing the latent vector to a corresponding dequantization codebook with the predefined fix decoder length. In one embodiment, each dequantization codebook is a scalar quantization or a vector quantization. In one embodiment, the one or more encoders are single-rate decoders, multi-rate decoders, or a combination of single-rate and multi-rate decoders.

In one embodiment, multi-rate AI/ML autoencoder is provided. The multi-rate AI/ML autoencoder includes a multi-encoder and multi-rate decoder. In one embodiment, the decoding AI model used by the decoder to perform generalization is of different nature from an encoding AI model used to generate the encoded data. In one embodiment, at least one of the encoding AI model or the decoding AI model is trained and stored by the apparatus. In another embodiment, at least one of the encoding AI model or the decoding AI model is obtained from a remote server.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary multi-rate encoder and decoder with generalization AI/ML models and the use of the encoder/decoder in a wireless network in accordance with embodiments of the current invention.

FIG. 2 illustrates exemplary diagrams for top level generalization at encoder and generalization at decoder in accordance with embodiments of the current invention.

FIG. 3 illustrates exemplary diagrams for deployment scenarios for multi-rate encoder and decoder in accordance with embodiments of the current invention.

FIG. 4 illustrates exemplary diagrams for splitting-based generalization for multi-rate encoder in accordance with embodiments of the current invention.

FIG. 5 illustrates exemplary diagrams for downsampling-based generalization for multi-rate encoder in accordance with embodiments of the current invention.

FIG. 6 illustrates exemplary diagrams for quantization-based generalization for multi-rate encoder in accordance with embodiments of the current invention.

FIG. 7 illustrates exemplary diagrams for zero-padding-based generalization for multi-rate decoder in accordance with embodiments of the current invention.

FIG. 8 illustrates exemplary diagrams for upsampling-based generalization for multi-rate decoder in accordance with embodiments of the current invention.

FIG. 9 illustrates exemplary diagrams for multi-rate AI/ML autoencoder in accordance with embodiments of the current invention.

FIG. 10 illustrates exemplary diagrams for a top-level multi-rate AI/ML autoencoder in accordance with embodiments of the current invention

FIG. 11 illustrates exemplary diagrams for variants of multi-rate AI/ML autoencoder in accordance with embodiments of the current invention.

FIG. 12A illustrates an exemplary flow chart for the multi-rate encoding with AI/ML generalization in accordance with embodiments of the current invention.

FIG. 12B illustrates an exemplary flow chart for the multi-rate decoding with AI/ML generalization in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system.

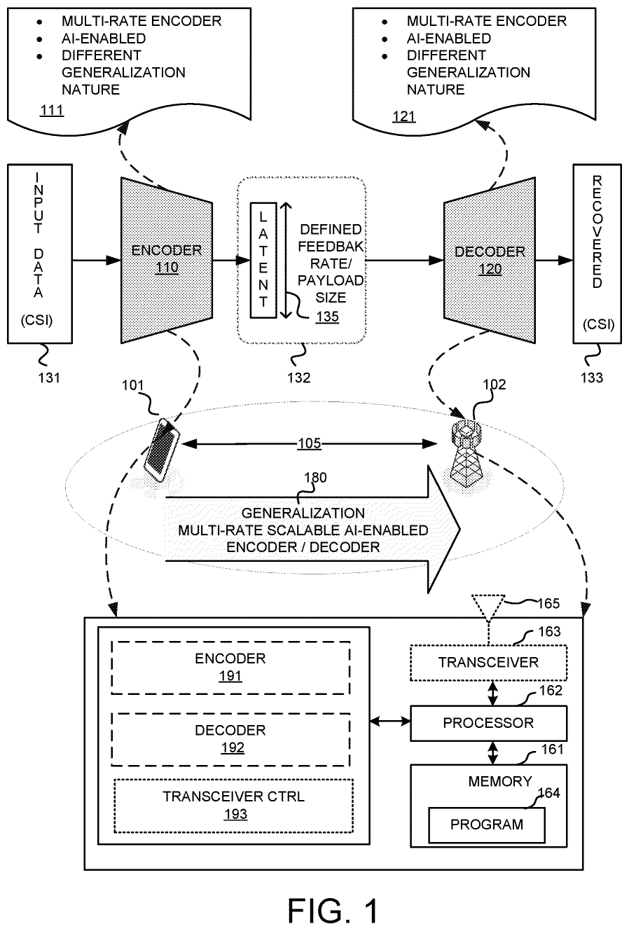

FIG. 1 is a schematic system diagram illustrating an exemplary multi-rate encoder and decoder with generalization AI/ML models and the use of the encoder/decoder in a wireless network in accordance with embodiments of the current invention. Wireless communication networks include one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks UE 101 has a Uu links with gNB 102, such as Uu link 105.

In one novel aspect 180, multi-rate encoder and/or decoder with generalization are used based on AI/ML model. In one use case, the AI-enabled multi-rate encoder and/or decoder are used for CSI compression in the wireless network. For the CSI compression cycle, the UE performs channel estimation, pre-processing, and compression. The UE obtains channel estimation data, possibly translates CSI to an intermediate domain, and compresses the pre-processed CSI to be sent to the gNB. On the gNB side, the gNB de-compresses the received CSI feedback, performs post-processing and precoding. For the wireless network, different accuracies and overheads of CSI feedback are required. In one embodiment, multi-rate decoder 110 and/or multi-rate decoder 120 are used. In one embodiment 111, encoder 110 is a multi-rate encoder and AI-enabled. The AI/Model for encoder 110 performs generalization with one or more natures/approaches. In one embodiment 111, encoder 110 is a multi-rate decoder and AI-enabled. The AI/Model for encoder 110 performs generalization with one or more natures/approaches. In one embodiment 121, decoder 120 is a multi-rate decoder and AI-enabled. The AI/Model for decoder 120 performs generalization with one or more natures/approaches. At step 131, input data, such as CSI are passed to encoder 110. At step 132, latent vector 135 is generated. For CSI feedback, accuracy is determined by the length of latent output from encoder 110. The encoded data is received by decoder 120. Multi-rated decoder 120 performs generalization procedure and recovers/reconstructs the CSI. In other embodiments, multi-rate encoder 110 resides in the UE and/or the gNB and multi-rate decoder 120 resides in the UE and/or the gNB.

FIG. 1 also includes simplified block diagrams of an apparatus with at least one of the multi-rate encoder and the multi-rate decoder, such as UE 101 and gNB 102. The apparatus has an antenna 165, which transmits and receives radio signals. An RF transceiver circuit 163, coupled with the antenna, receives RF signals from antenna 165, converts them to baseband signals, and sends them to processor 162. In one embodiment, the RF transceiver 163 may comprise two RF modules (not shown) which are used for different frequency bands transmitting and receiving. RF transceiver 163 also converts received baseband signals from processor 162, converts them to RF signals, and sends out to antenna 165. Processor 162 processes the received baseband signals and invokes different functional modules to perform features in the apparatus. Memory 161 stores program instructions and data 164 to control the operations of the apparatus. Antenna 165 sends uplink transmission and receives downlink transmissions to/from antenna 156 of gNB 103.

The apparatus also includes a set of control modules that carry out functional tasks. These control modules can be implemented by circuits, software, firmware, or a combination of them. The apparatus includes at least one of encoder module 191 and decoder module 192. Encoder module 191 receives an input data, generates intermediate encoder vector with a predefined length, performs generalization using the intermediate output vector with an encoding AI model to generate multiple latent vectors, wherein a length of each latent vector is different, wherein the generalization with the encoding AI model is one selecting from a splitting-based generalization, a downsampling-based generalization, and a quantization-based generalization. Decoder module 192 receives encoded data, wherein the encoded data is a latent vector, performs generalization the encoded data with a decoding AI model to generate corresponding intermediate decoder vector with a predefined fix decoder length, wherein the generalization with the decoding AI model is one selectin from a zero-padding-based generalization, an upsampling-based generalization, and a dequantization-based generalization. Optionally, the apparatus includes transceiver control module 193 that performs configuration and control functions for data transceiving.

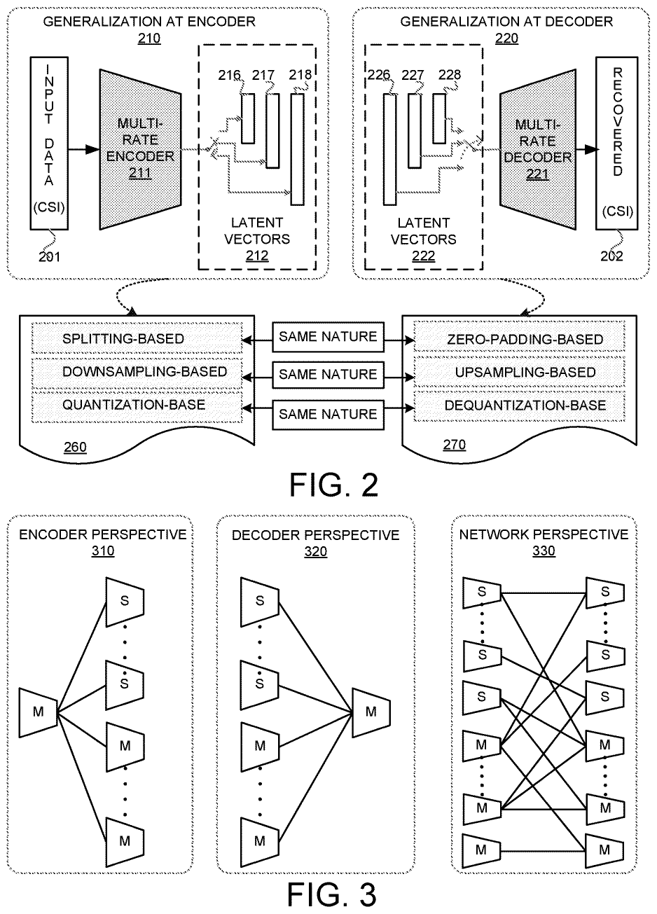

FIG. 2 illustrates exemplary diagrams for top level generalization at encoder and generalization at decoder in accordance with embodiments of the current invention. In one novel aspect, generalization at encoder 210 and/or generalization at decoder 220 is performed to enable multi-rate encoding and/or decoding. In one use case, CSI feedback is generated with two or more different lengths. The decoder recovers CSI from feedback with two or more different lengths. In one embodiment 210, input data, such as CSI feedback 201 is passed to multi-rate encoder 211. Multi-rate encoder 211 is AI-enabled and is trained and generates latent vectors (212) with different sizes, such as 216, 127, and 218. In one embodiment 220, latent vectors 222 is passed to multi-rate decoder 221. Latent vectors, such as 226, 227, and 228 are with different sizes. Multi-rate decoder 221 is AI-enabled and is trained and generates recovered data, such as recovered CSI with a predefined length. In one embodiment 260, the generalization at the encoder is one procedure selecting from a splitting-based generalization, a downsampling-based generalization, and a quantization-based generalization. In one embodiment 270, the generalization performed at the decoder is one procedure selecting from a zero-padding-based generalization, an upsampling-based generalization, and a dequantization-based generalization. The splitting-based generalization at the encoder is of the same nature/approach as the zero-padding-based generalization at the decoder. The downsampling generalization at the encoder is of the same nature/approach as the upsampling-based generalization at the decoder. The quantization-based generalization at the encoder is of the same nature/approach as the dequantization-based generalization at the decoder.

FIG. 3 illustrates exemplary diagrams for deployment scenarios for multi-rate encoder and decoder in accordance with embodiments of the current invention. From the encoder's perspective 310, the multi-rate encoder can pass the encoded data to a number of single-rate decoders and/or a number of multi-rate decoders. The number of sign-rate and/or multi-rate decoders deployed to receive the encoded data from the multi-rate encoder ranges from zero to many. From the encoder's perspective 320, the multi-rate decoder receives encoded data from a number of single-rate decoders and/or a number of multi-rate encoders. The number of sign-rate and/or multi-rate encoders deployed send the encoded data to the multi-rate decoder ranges from zero to many. From the network perspective 330, a number of multi-rated encoders and/or single-rated encoders work with a number of single-rate decoders and/or a number of multi-rate decoders. The number of sing-rate and/or multi-rate encoders and decoders ranges from zero to many.

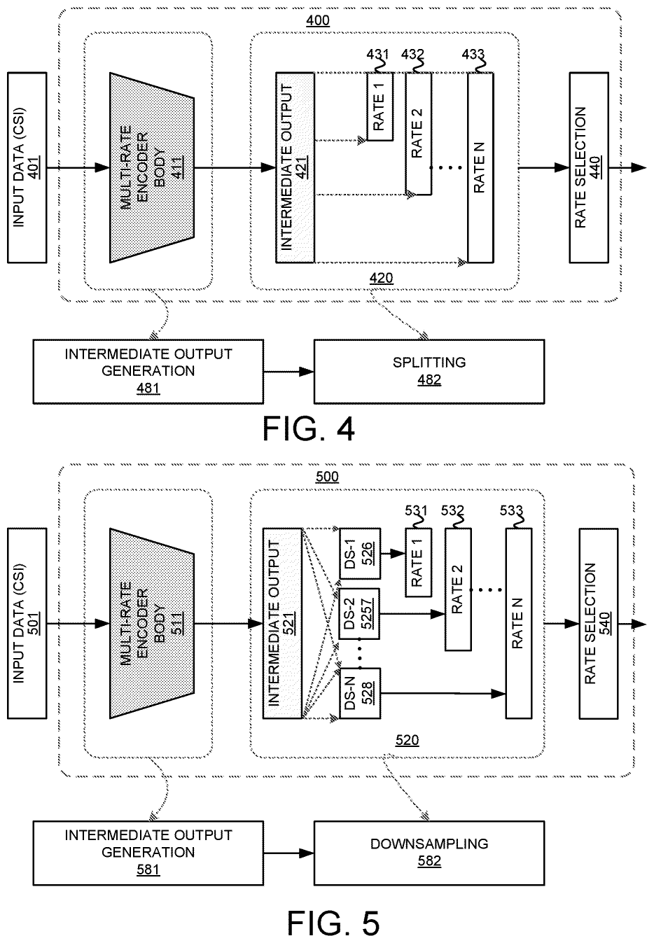

FIG. 4 illustrates exemplary diagrams for splitting-based generalization for multi-rate encoder in accordance with embodiments of the current invention. AI-enabled multi-rate encoder 400 is provided with splitting-based generalization. Input data, such as CSI 401 is received by multi-rate encoder body 411. Encoder 411 generates an intermediate output vector 421 with a predefined length. Multiple latent vectors 420 with different desired lengths are generated, such as latent vector 431 with rate-1, 432 with rate-2 and 433 with rate-N. A rate selection 440 selects a desired encoding rate. The splitting-based generalization includes intermediate output generation (step 481) and splitting/selecting a portion of the intermediate output to generate a latent vector of desired length (step 482).

FIG. 5 illustrates exemplary diagrams for downsampling-based generalization for multi-rate encoder in accordance with embodiments of the current invention. AI-enabled multi-rate encoder 500 is provided with downsampling-based generalization. Input data, such as CSI 501 is received by multi-rate encoder body 511. Encoder 511 generates an intermediate output vector 521 with a predefined length. Intermediate output 521 flows to different downsamplers, such as downsampler (DS)-1 526, DS-2 527 and DS-N 528. Each down sampler is designed for a pre-defined rate/feedback length. Such as DS-1 526 generates latent vector 531 with rate-1, DS-2 527 generates latent vector 532 with rate-2, DS-N 528 generates latent vector 533 with rate-N. In one embodiment, the downsamplers are made of fully-connected layers. A rate selection 540 selects a desired encoding rate. The downsampling-based generalization includes intermediate output generation (step 581) and downsampling the intermediate output to generate a latent vector of desired length (step 582).

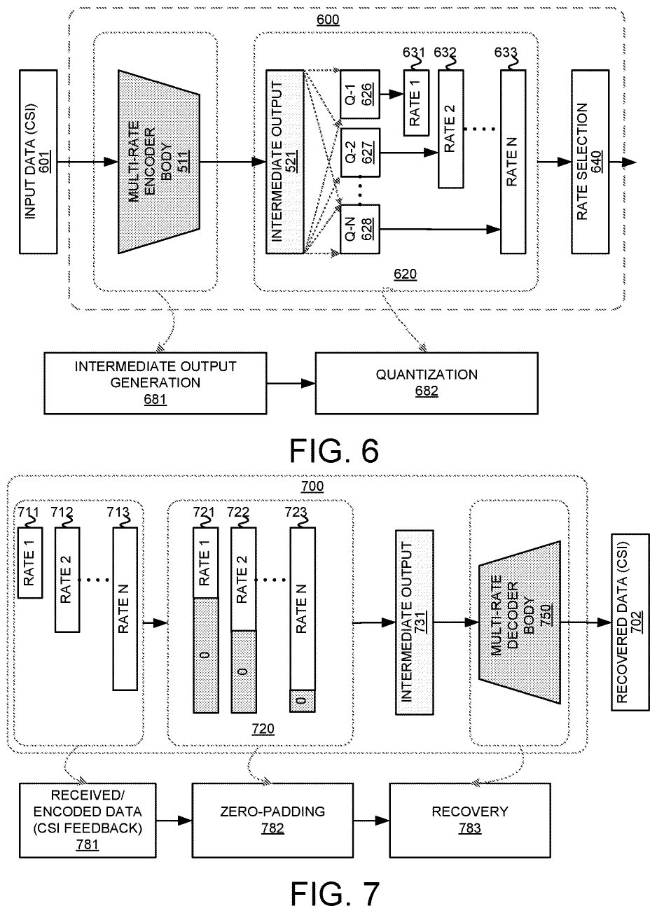

FIG. 6 illustrates exemplary diagrams for quantization-based generalization for multi-rate encoder in accordance with embodiments of the current invention. AI-enabled multi-rate encoder 600 is provided with quantization-based generalization. Input data, such as CSI 601 is received by multi-rate encoder body 611. Encoder 611 generates an intermediate output vector 621 with a predefined length. Intermediate output 621 flows to different quantization codebooks, such as quantization codebook-1 (Q-1) 626, Q-2 627, and Q-N 628. Each quantization codebook is designed for a pre-defined rate/feedback length. In one embodiment, the codebook is scalar or vector quantization. For example, Q-1 626 generates latent vector 631 with rate-1, Q-2 627 generates latent vector 632 with rate-2, Q-N 628 generates latent vector 633 with rate-N. A rate selection 640 selects a desired encoding rate. The quantization-based generalization includes intermediate output generation (step 681) and quantization procedure for the intermediate output to generate a latent vector of desired length (step 682).

FIG. 7 illustrates exemplary diagrams for zero-padding-based generalization for multi-rate decoder in accordance with embodiments of the current invention. AI-enabled multi-rate decoder 700 is provided with zero-padding-based generalization. The decoder receives encoded data with different lengths, such as CSI feedback 711 with rate-1, 712 with rate-2 and 713 with rate-N. Zero-padding 720 is performed to zero pad the received encoded data until the zero-padded data, such as 721, 722, and 722 reaches to a predefined fix length, which is expected by the decoder. The zero-padding intermediate output 731 is passed to the multi-rate decode body 750, which generates recovered data 702, such as recovered CSI. The zero-padding-based generalization includes receiving encoded data, such as CSI feedback (step 781), zero-padding the encoded data to an intermediate output with a predefined length (step 782), and recover the data based on the intermediate output (step 783).

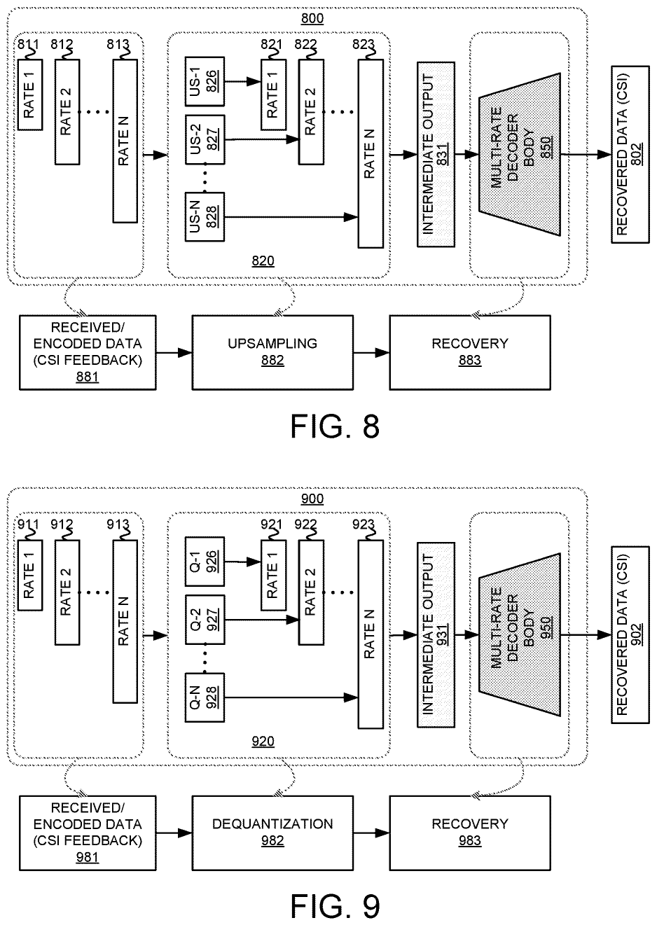

FIG. 8 illustrates exemplary diagrams for upsampling-based generalization for multi-rate decoder in accordance with embodiments of the current invention. AI-enabled multi-rate decoder 800 is provided with upsampling-based generalization. The decoder receives encoded data with different lengths, such as CSI feedback 811 with rate-1, 812 with rate-2 and 813 with rate-N. The received data goes through upsamplers 820. In one embodiment, the upsamplers are made of fully connected layers. Each upsampler (US) translates the received encoded data, such CSI feedback, with a certain rate to an intermediate input 831. For example, US-1 826 translates encoded data with rate-1 821 to the fixed length intermediate output data; US-2 827 translates encoded data with rate-1 822 to the fixed length intermediate output data; US-N 828 translates encoded data with rate-N 823 to the fixed length intermediate output data. The intermediate output 831 is passed to the multi-rate decode body 850, which generates recovered data 802, such as recovered CSI. The upsampling-based generalization includes receiving encoded data, such as CSI feedback (step 881), upsampling the encoded data to an intermediate output with a predefined length (step 882), and recover the data based on the intermediate output (step 883).

FIG. 9 illustrates exemplary diagrams for multi-rate AI/ML autoencoder in accordance with embodiments of the current invention. AI-enabled multi-rate decoder 900 is provided with dequantization-based generalization. The decoder receives encoded data with different lengths, such as CSI feedback 911 with rate-1, 912 with rate-2 and 913 with rate-N. The received data goes through different dequantization codebooks. In one embodiment, the dequantization codebook is scalar or vector quantization codebook. Each dequantizer (DQ) of the dequantization module 920 translates the received encoded data, such CSI feedback, with a certain rate to an intermediate input 931. For example, Q-1 926 translates encoded data with rate-1 921 to the fixed length intermediate output data; Q-2 927 translates encoded data with rate-1 922 to the fixed length intermediate output data; Q-N 928 translates encoded data with rate-N 923 to the fixed length intermediate output data. The intermediate output 931 is passed to the multi-rate decode body 950, which generates recovered data 902, such as recovered CSI. The dequantization-based generalization includes receiving encoded data, such as CSI feedback (step 981), dequantizing the encoded data to an intermediate output with a predefined length (step 882), and recover the data based on the intermediate output (step 883).

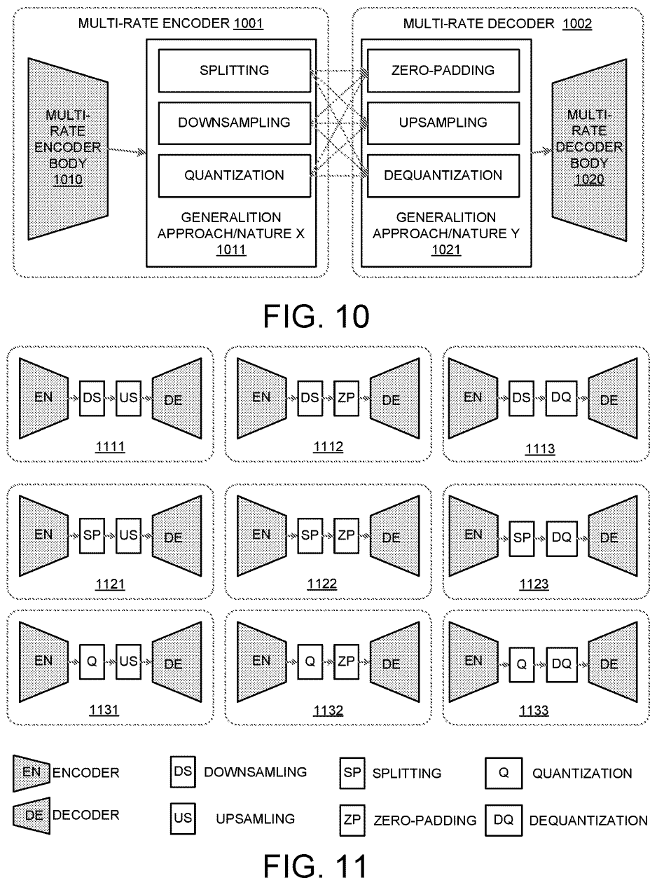

FIG. 10 illustrates exemplary diagrams for a top-level multi-rate AI/ML autoencoder in accordance with embodiments of the current invention. In one embodiment, multi-rate AI/ML autoencoder is provided. Multi-rate AI/ML autoencoder is formed of a multi-rate encoder 1001 working with a multi-rate decoder 1002. Multi-rate encoder 1001 includes a multi-rate encoder body 1010 and generalization module 1011 with one or more generalization natures/approaches, including splitting-base, downsampling-based and quantization-based generalizations. Multi-rate decoder 1002 includes a multi-rate encoder body 1020 and generalization module 1021 with one or more generalization natures/approaches, including zero-padding-based, upsampling-based and dequantization-based generalizations. In one embodiment, the decoding AI model used by the decoder to perform generalization is of different nature/approach from an encoding AI model used to generate the encoded data. The rate generalization approach at the encoder and the decoder can be of the same nature, such as quantization-based generalization at the encoder with dequantization-based generalization at the decoder, or downsampling-based generalization at the encoder with upsampling-based generalization at the decoder, or splitting-based generalization at the encoder with zero-padding-based generalization at the decoder. In other scenarios, rate generalization approach at the encoder and the decoder are not of the same nature. In one embodiment, the AI model for the encoder and/or the decoder is trained and stored with the apparatus where the encoding and/or decoding is performed. In another embodiment, the AI model for the encoder and/or decoder is downloaded by the apparatus from the network, such as an AI server.

FIG. 11 illustrates exemplary diagrams for variants of multi-rate AI/ML autoencoder in accordance with embodiments of the current invention. Different variants of AI/ML model combination for the encoder and decoder are presented. In one scenario/variant 1111, encoder is downsampling-based generalization, and the decoder is upsampling-based generalization. In one scenario/variant 1112, encoder is downsampling-based generalization, and the decoder is zero-padding-based generalization. In one scenario/variant 1113, encoder is downsampling-based generalization, and the decoder is dequantization-based generalization. In one scenario/variant 1121, encoder is splitting-based generalization, and the decoder is upsampling-based generalization. In one scenario/variant 1122, encoder is splitting-based generalization, and the decoder is zero-padding-based generalization. In one scenario/variant 1123, encoder is splitting-based generalization, and the decoder is dequantization-based generalization. In one scenario/variant 1131, encoder is quantization-based generalization, and the decoder is upsampling-based generalization. In one scenario/variant 1132, encoder is quantization-based generalization, and the decoder is zero-padding-based generalization. In one scenario/variant 1133, encoder is quantization-based generalization, and the decoder is dequantization-based generalization.

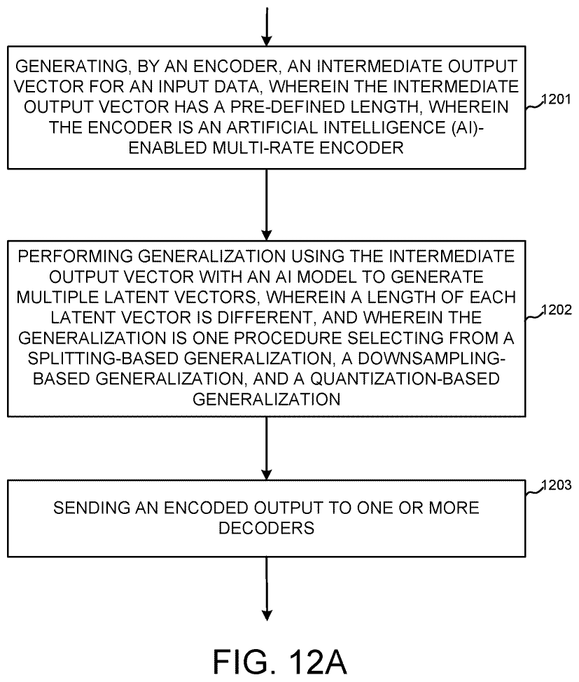

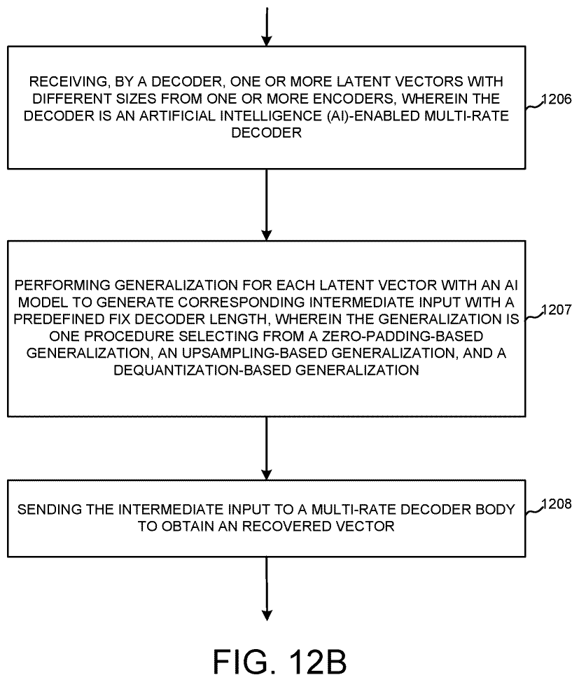

FIG. 12A illustrates an exemplary flow chart for the multi-rate encoding with AI/ML generalization in accordance with embodiments of the current invention. At step 1201, the encoder generates an intermediate output vector for an input data, wherein the intermediate output vector has a pre-defined length, wherein the encoder is an artificial intelligence (AI)-enabled multi-rate encoder. At step 1202, the encoder performs generalization using the intermediate output vector with an AI model to generate multiple latent vectors, wherein a length of each latent vector is different, and wherein the generalization is one procedure selecting from a splitting-based generalization, a downsampling-based generalization, and a quantization-based generalization. At step 1203, the encoder sends an encoded output to one or more decoders.

FIG. 12B illustrates an exemplary flow chart for the multi-rate decoding with AI/ML generalization in accordance with embodiments of the current invention. At step 1206, the decoder receives one or more latent vectors with different sizes from one or more encoders, wherein the decoder is an artificial intelligence (AI)-enabled multi-rate decoder. At step 1207, the decoder performs generalization for each latent vector with an AI model to generate corresponding intermediate input with a predefined fix decoder length, wherein the generalization is one procedure selecting from a zero-padding-based generalization, an upsampling-based generalization, and a dequantization-based generalization. At step 1208, the decoder the intermediate input to a multi-rate decoder body to obtain a recovered vector.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
generating, by an encoder, an intermediate output vector for an input data, wherein the intermediate output vector has a pre-defined length, wherein the encoder is an artificial intelligence (AI)-enabled multi-rate encoder;
performing generalization using the intermediate output vector with an AI model to generate multiple latent vectors, wherein a length of each latent vector is different, and wherein the generalization is one procedure selecting from a splitting-based generalization, a downsampling-based generalization, and a quantization-based generalization; and
sending an encoded output to one or more decoders.

2. The method of claim 1, wherein the input data is channel state information (CSI) obtained by an apparatus in a wireless network.

3. The method of claim 1, wherein the splitting-based generalization involves: for each latent vector, selecting a portion of the intermediate output vector with a selection length equals to the length of corresponding latent vector.

4. The method of claim 1, wherein the downsampling-based generalization involves: for each latent vector, passing the intermediate output vector to a corresponding downsampler with a predefined length equals to the length of corresponding latent vector.

5. The method of claim 1, wherein the quantization-based generalization involves: for each latent vector, passing the intermediate output vector to a corresponding quantization codebook with predefined length equals to the length of corresponding latent vector.

6. The method of claim 5, wherein each quantization codebook is a scalar quantization or a vector quantization.

7. The method of claim 1, wherein the one or more decoders are single-rate decoders, multi-rate decoders, or a combination of single-rate and multi-rate decoders.

8. A method, comprising:
receiving, by a decoder, one or more latent vectors with different sizes from one or more encoders, wherein the decoder is an artificial intelligence (AI)-enabled multi-rate decoder;
performing generalization for each latent vector with an AI model to generate corresponding intermediate input with a predefined fix decoder length, wherein the generalization is one procedure selecting from a zero-padding-based generalization, an upsampling-based generalization, and a dequantization-based generalization; and
sending the intermediate input to a multi-rate decoder body to obtain a recovered vector.

9. The method of claim 8, wherein the one or more latent vectors are encoded channel state information (CSI) obtained by an apparatus in a wireless network.

10. The method of claim 8, wherein the zero-padding-based generalization involves: for each latent vector, performing zero-padding to get the immediate vector with the predefined fix decoder length.

11. The method of claim 8, wherein the upsampling-based generalization involves: for each latent vector, passing the latent vector to a corresponding upsampler to get the immediate vector with the predefined fix decoder length.

12. The method of claim 8, wherein the dequantization-based generalization involves: for each latent vector, passing the latent vector to a corresponding dequantization codebook with the predefined fix decoder length.

13. The method of claim 12, wherein each dequantization codebook is a scalar quantization or a vector quantization.

14. The method of claim 8, wherein the one or more encoders are single-rate decoders, multi-rate decoders, or a combination of single-rate and multi-rate decoders.

15. An apparatus, comprising:
at least an encoder or a decoder, wherein the encoder is an artificial intelligence (AI)-enabled multi-rate encoder, and the decoder is an AI-enabled multi-rate decoder, wherein
the encoder receives an input data, generates intermediate encoder vector with a predefined length, performs generalization using the intermediate output vector with an encoding AI model to generate multiple latent vectors, wherein a length of each latent vector is different, wherein the generalization with the encoding AI model is one selecting from a splitting-based generalization, a downsampling-based generalization, and a quantization-based generalization; and
the decoder receives encoded data, wherein the encoded data is a latent vector, performs generalization the encoded data with a decoding AI model to generate corresponding intermediate decoder vector with a predefined fix decoder length, wherein the generalization with the decoding AI model is one selectin from a zero-padding-based generalization, an upsampling-based generalization, and a dequantization-based generalization.

16. The apparatus of claim 15, wherein the decoding AI model used by the decoder to perform generalization is of different nature from an encoding AI model used to generate the encoded data.

17. The apparatus of claim 15, wherein at least one of the encoding AI model or the decoding AI model is trained and stored by the apparatus.

18. The apparatus of claim 15, wherein at least one of the encoding AI model or the decoding AI model is obtained from a remote server.

19. The apparatus of claim 15, wherein the apparatus is a user equipment in a wireless network, and wherein the encoder encodes channel state information (CSI) with multi-rate.

20. The method of claim 15, wherein the apparatus is a base station in a wireless network, and wherein the decoder decodes multi-rate CSIs.
